(19) United States
(12) Patent Application Publication
(10) Pub. No.: US 2011/0202322 A1
(43) Pub. Date: Aug. 18, 2011

(54) Computer Implemented Method for Discovery of Markov Boundaries from Datasets with Hidden Variables

(76) Inventors: Alexander Statnikov, New York, NY (US); Konstantinos (Constantin) F. Aliferis, New York, NY (US)

(21) Appl. No.: 12/689,944

(22) Filed: Jan. 19, 2010

Related U.S. Application Data
(60) Provisional application No. 61/145,652, filed on Jan. 19, 2009.

(51) Int. Cl. G06F 17/10

(52) U.S. Cl. 703/2

(57) ABSTRACT

Methods for Markov boundary discovery are important recent developments in pattern recognition and applied statistics, primarily because they offer a principled solution to the variable/feature selection problem and give insight about local causal structure. Currently there exist two major local method families for identification of Markov boundaries from data: methods that directly implement the definition of the Markov boundary and newer compositional Markov boundary methods that are more sample efficient and thus often more accurate in practical applications. However, in the datasets with hidden (i.e., unmeasured or unobserved) variables compositional Markov boundary methods may miss some Markov boundary members. The present invention circumvents this limitation of the compositional Markov boundary methods and proposes a new method that can discover Markov boundaries from the datasets with hidden variables and do so in a much more sample efficient manner than methods that directly implement the definition of the Markov boundary. In general, the inventive method transforms a dataset with many variables into a minimal reduced dataset where all variables are needed for optimal prediction of some response variable. The power of the invention was empirically demonstrated with data generated by Bayesian networks and with 13 real datasets from a diversity of application domains.

Benefit of U.S. Provisional Application No. 61/145,652 filed on Jan. 19, 2009 is hereby claimed.

### BACKGROUND OF THE INVENTION

1. Field of the Invention

Methods for Markov boundary discovery are important recent developments in pattern recognition and applied statistics, primarily because they offer a principled solution to the variable/feature selection problem and give insight about local causal structure. The present invention is a novel method to discover Markov boundaries from datasets that may contain hidden (i.e., unmeasured or unobserved) variables. In general, the inventive method transforms a dataset with many variables into a minimal reduced dataset where all variables are needed for optimal prediction of some response variable. For example, medical researchers have been trying to identify the genes responsible for human diseases by analyzing samples from patients and controls by gene expression microarrays. However, they have been frustrated in their attempt to identify the critical elements by the highly complex pattern of expression results obtained, often with thousands of genes that are associated with the phenotype. A method has been discovered to transform the gene expression microarray dataset for thousands of genes into a much smaller dataset containing only genes that are necessary for optimal prediction of the phenotypic response variable. Likewise, the invention described in this patent document can transform a dataset containing frequencies of thousands of words and terms used in the articles into a much smaller dataset with only words/terms that are necessary for optimal prediction of the subject category of the article.

The power of the invention is first demonstrated in data simulated from Bayesian networks from several problem domains, where the invention can identify Markov boundaries more accurately than the baseline comparison methods. The broad applicability of the invention is subsequently demonstrated with 13 real datasets from a diversity of application domains, where the inventive method can identify Markov boundaries of the response variable with larger median classification performance than other baseline comparison methods.

2. Description of Related Art

Markov boundary discovery can be accomplished by learning a Bayesian network or other causal graph and extracting the Markov boundary from the graph. This is called a “global” approach because it learns a model involving all variables. A much more recent and scalable invention is “local” methods that learn directly the Markov boundary without need to learn first a large and complicated model, an operation that is unnecessarily complex in most cases and often may be intractable as well. There exist two major local method families for identification of Markov boundaries from data. The first family contains methods that directly implement the definition of the Markov boundary (Pearl, 1988) by conditioning on the iteratively improved approximation of the Markov boundary and assessing conditional independence of remaining variables. For example, GS and IAMB-style methods belong to this class (Margaritis and Thrun, 1999; Tsamardinos and Aliferis, 2003; Tsamardinos et al., 2003a). The second family contains compositional Markov boundary methods that are more sample efficient and thus often more accurate in practical applications. Methods of this class operate by first learning a set of parents and children of the response/target variable using a specially designated sub-method, then using this sub-method to learn a set of parents and children of the parents and children of the response variable, and finally using another sub-method to eliminate all non-Markov boundary members. An example of such compositional Markov boundary method is GLL-MB (Aliferis et al., 2009a; Aliferis et al., 2009b; Aliferis et al., 2003; Tsamardinos et al., 2003b). Methods in both classes identify correctly a Markov boundary of the response/target variable under the assumptions of faithfulness and causal sufficiency (Spirtes et al., 2000). The latter assumption implies that every common cause of any two or more variables is observed in the dataset. However, this assumption is very restrictive and is violated in most real datasets. Closer examination of the assumptions of methods that directly implement the definition of Markov boundary reveals that these methods can identify a Markov boundary even when the causal sufficiency assumption is violated. This is primarily because these methods require only the composition property which does hold when some variables are not observed in the data (Peña et al., 2007; Statnikov, 2008). However, in the datasets with hidden variables compositional Markov boundary methods may miss some Markov boundary members. The present invention circumvents this limitation of compositional Markov boundary methods and describes a new method that can discover Markov boundaries from the datasets with hidden variables and do so in a much more sample efficient manner than methods that directly implement the definition of Markov boundary.

### DESCRIPTION OF THE FIGURES AND TABLES

Table 1 shows the Core method.

Table 2 shows the generative method CIMB1.

Table 3 shows the generative method CIMB2.

Table 4 shows the generative method CIMB3.

Table 5 shows the pseudo-code to implement generative method CIMB1 on a digital computer.

Table 6 shows the method CIMB*. Sub-routines Find-Spouses1 and Find-Spouses2 are described in Tables 7 and 8, respectively.

Table 7 shows the sub-routine Find-Spouses1 that is used in the method CIMB*.

Table 8 shows the sub-routine Find-Spouses2 that is used in the method CIMB*.

Table 9 shows the sensitivity of Markov boundary discovery for evaluation of Markov boundary methods using data from Bayesian networks. The larger is this metric, the more accurate is the method.

Table 10 shows the specificity of Markov boundary discovery for evaluation of Markov boundary methods using data from Bayesian networks. The larger is this metric, the more accurate is the method.

Table 11 shows the error of Markov boundary discovery (computed as distance from the optimal point in ROC space with sensitivity=1 and specificity=1) for evaluation of Markov boundary methods using data from Bayesian networks. The error is computed as described in (Frey et al., 2003). The smaller is the error, the more accurate is the method.

Table 12 shows classification performance of the invention and baseline comparison methods in 13 real datasets listed in Table S2. The classification performance is measured by area under ROC (AUC) curve metric.

Table 13 shows the proportion of selected features applying the invention and baseline comparison methods in 13 real datasets listed in Table S2.

FIG. 1 shows an example causal structure: (a) true structure and (b) structure identified by CIMB* at current point of operation of the method. The semantics of edges is given in the Appendix.

FIG. 2 shows an example causal structure: (a) true structure and (b) structure identified by CIMB* at current point of operation of the method. The semantics of edges is given in the Appendix.

FIG. 3 shows an example causal structure: (a) true structure and (b) structure identified by CIMB* at current point of operation of the method. The semantics of edges is given in the Appendix.

FIG. 4 shows an example causal structure. The semantics of edges is given in the Appendix.

FIG. 5 shows the sensitivity of Markov boundary discovery for evaluation of Markov boundary methods using data from Bayesian networks. The horizontal axis is sample size; the vertical axis is sensitivity.

FIG. 6 shows the error of Markov boundary discovery (computed as distance from the optimal point in ROC space) for evaluation of Markov boundary methods using data from Bayesian networks. The horizontal axis is sample size; the vertical axis is error.

### APPENDIX TABLES

Table S1 shows a list of 7 Bayesian networks used in experiments to evaluate CIMB*.

Table S2 shows a list of 13 real datasets used in experiments to evaluate CIMB*.

Table S3 shows a method to process graphs of Bayesian networks without hidden variables to generate experiment tuples for evaluation of Markov boundary methods.

### DETAILED DESCRIPTION OF THE INVENTION

This specification teaches a novel method for discovery of a Markov boundary of the response/target variable from datasets with hidden variables (specifically, the method identifies a Markov boundary of the response/target variable in the distribution over observed variables). The novel method relies on the assumption that the distribution over all variables (observed and unobserved) involved in the underlying causal process is faithful to some DAG (Spirtes et al., 2000) (whereas the distribution over a subset consisting of the observed variables may be unfaithful). In general, the inventive method transforms a dataset with many variables into a minimal reduced dataset where all variables are needed for optimal prediction of some response variable. Notation and key definitions are described in the Appendix.

The Core method for finding a Markov boundary of the response/target variable in the distributions where possibly not all variables have been observed is described in Table 1. Several ways to apply this methodology are described herein. In particular, three generative methods CIMB1, CIMB2, CIMB3 are described in Tables 2, 3, 4, respectively. The term “generative method” refers to a method that can be instantiated (parameterized) in a plurality of ways such that each instantiation provides a specific process to solve the problem of finding a Markov boundary of T in the distributions where possibly not all variables have been observed such that the distribution over all (observed and unobserved) variables involved in the causal process is faithful.

The invention consists of:
(a) The Core method (Table 1).
(b) The CIMB1, CIMB2, and CIMB3 generative methods (Tables 2-4) being exemplars of the Core method.
(c) A plurality of instantiations of CIMB1, CIMB2, CIMB3 demonstrating how these generative methods can be configured when reduced to practice (e.g., see Table 5).
(d) A method CIMB* (Tables 6-8) that applies the Core method while incorporating efficiency optimizations to speed up operation of the Core method when implemented using a general-purpose digital computer.
(e) Variants of the CIMB* method, termed CIMB*1 and CIMB*2 (described below).
   A pseudo-code to implement the method CIMB1 is provided in Table 5. Other implementations of the method CIMB1 can be obtained by instantiating its steps as follows (refer to Table 2 for steps mentioned below):
Step 2: Any strategy to iterate over variables Z ∈ V\(TMB(T)∪{T}) can be employed. For example, one can use the strategy outlined in the pseudo-code that implements CIMB1 (Table 5) or the more efficient strategy that is described in the CIMB* method below (Tables 6-8). Those who are skilled in the art can implement many additional known iteration strategies.
Step 3: Any backward elimination strategy can be used. Those who are skilled in the art will recognize many suitable known methods such as the wrapper methods described in (Kohavi and John, 1997).
Step 1 of the sub-routine to determine whether X has a collider path to T: Any available local or global method to learn a causal graph G to identify the existence of a collider path between X and T can be selected by those who are skilled in the art. For example, one can use the FCI and PC methods implemented in TETRAD software (Spirtes et al., 2000). Similarly, one can use the approach outlined in the CIMB* method that is described below (Tables 6-8).
   Implementations of the method CIMB2 can be obtained by instantiating its steps as follows (refer to Table 3 for steps mentioned below):
Step 2: Any method that learns a causal graph G over V can be employed. Those who are skilled in the art can recognize that the FCI and PC methods implemented in TETRAD software (Spirtes et al., 2000) can be used.
Step 4: Any backward elimination strategy can be used. Those who are skilled in the art will recognize many suitable known methods such as the wrapper methods described in (Kohavi and John, 1997).

Implementations of the method CIMB3 can be obtained by instantiating its steps as follows (refer to Table 4 for steps mentioned below):
Steps 2 and 3: Any forward selection and backward elimination strategies can be used. Those who are skilled in the art will recognize many known suitable methods such as the wrapper methods described in (Kohavi and John, 1997).
Step 2: Apply the forward selection strategy by prioritizing variables for inclusion in TMB(T) according to:
   the strength of their association with T.
   the strength of their association with K where K is member of the current TMB(T).
   the membership of variables in GLL-PC(K) where K is a member of the current TMB(T).

The method CIMB* described in Table 6 is an instantiation of the Core method and also can be seen as a variant of CIMB1. First, CIMB* uses an efficient strategy to consider only potential members of the Markov boundary. In other words, it does not iterate over all Z ∈ V\(TMB(T)∪{T}), but it iterates only over a subset of V\(TMB(T)∪{T}). Second, the approach used for identification of a collider path to T (that is used in the sub-routine of CIMB1) is based on recursive application of the GLL-PC method (to build regions of the network) and subsequent application of the collider orientation rules that are described in the sub-routines Find-Spouses1 (Table 7) and Find-Spouses2 (Table 8) and in steps 19-29 of the CIMB* method (Table 6).

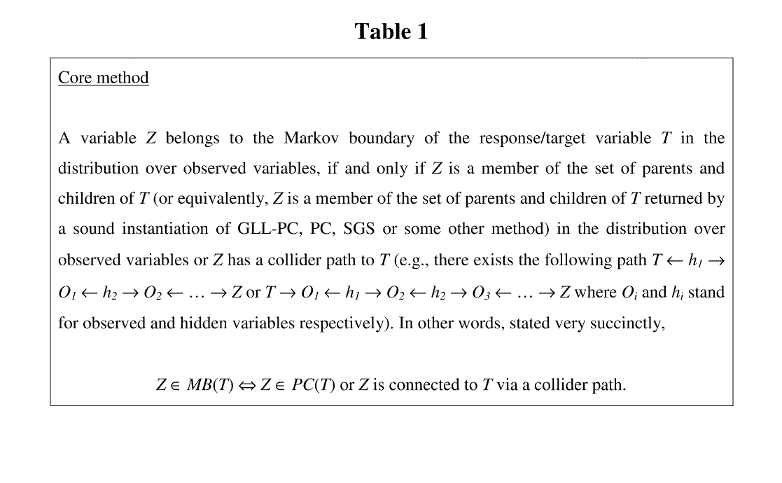

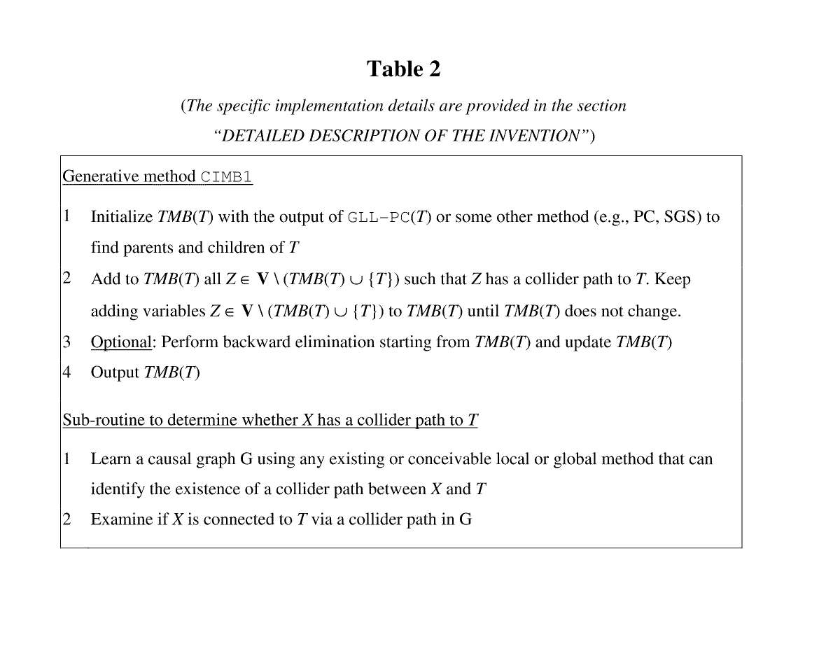

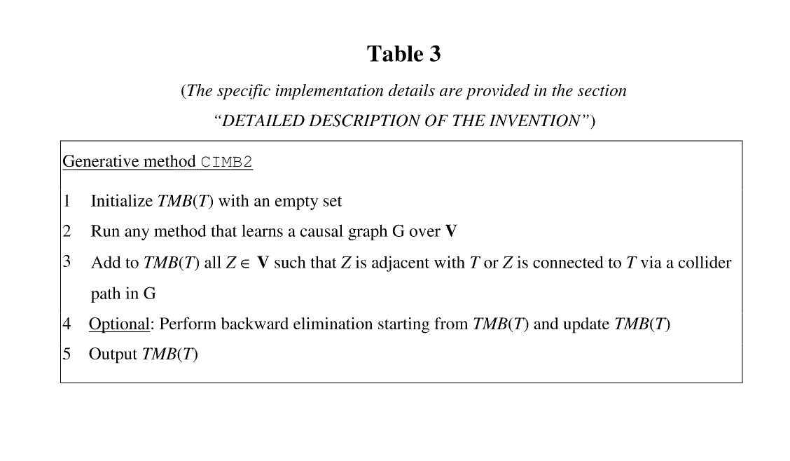

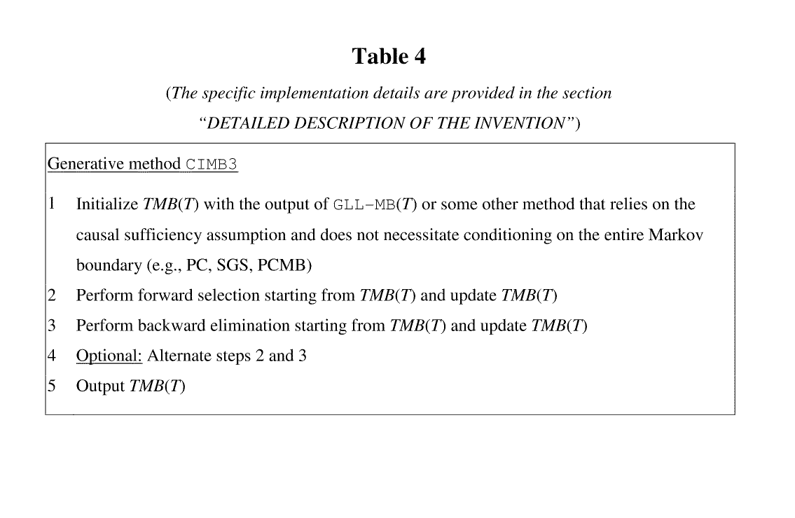

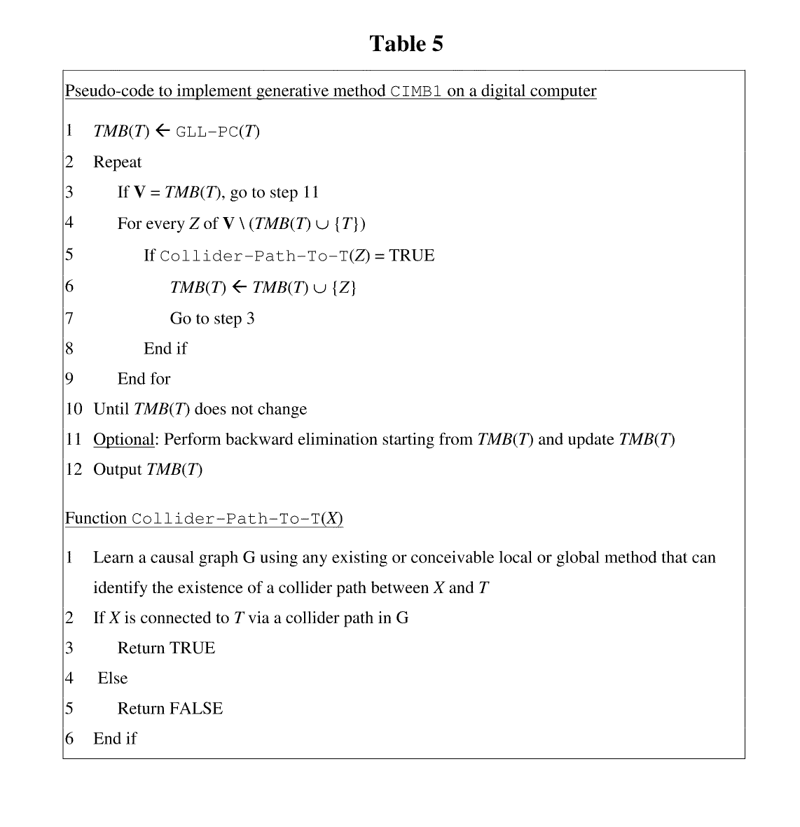

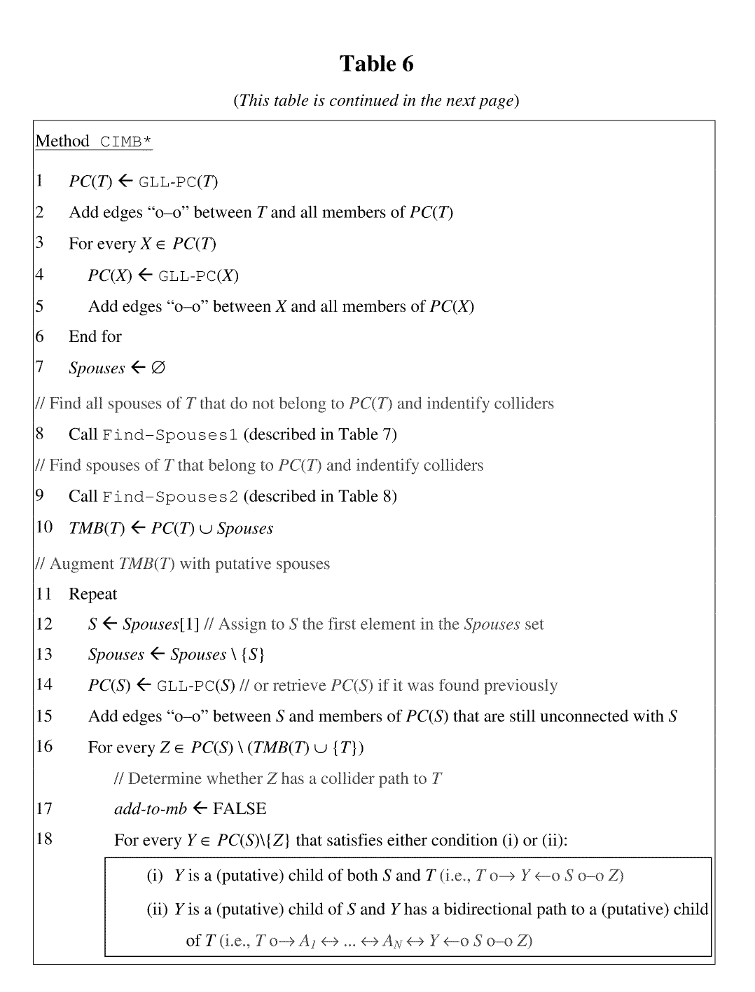

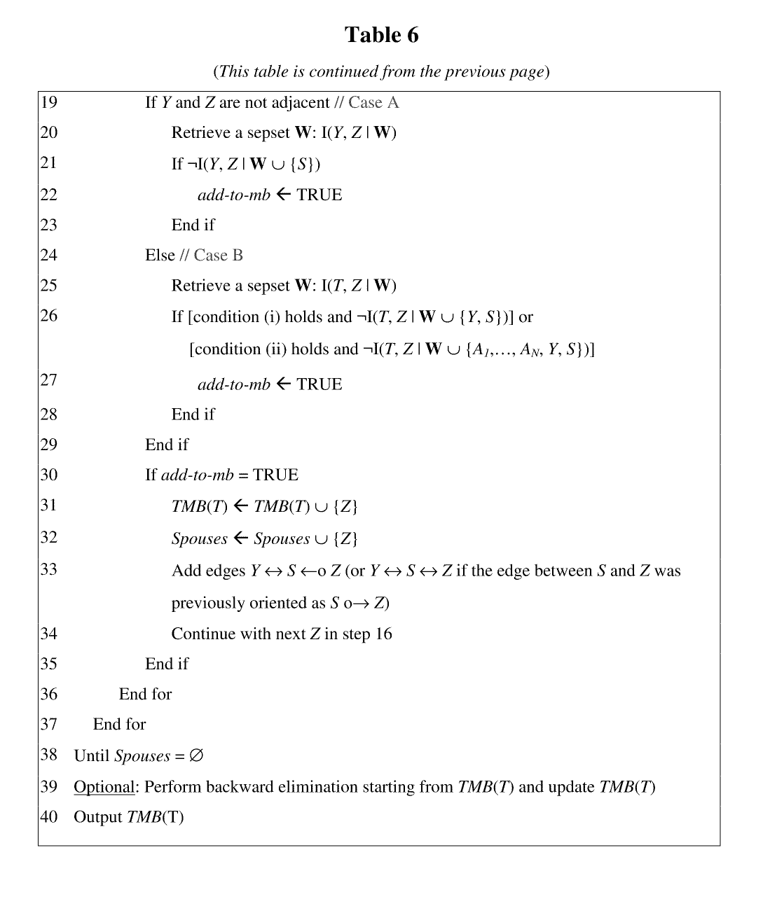

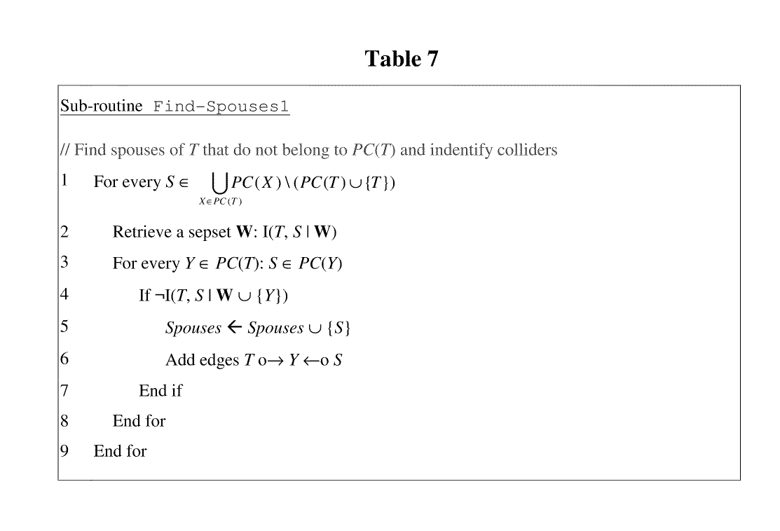

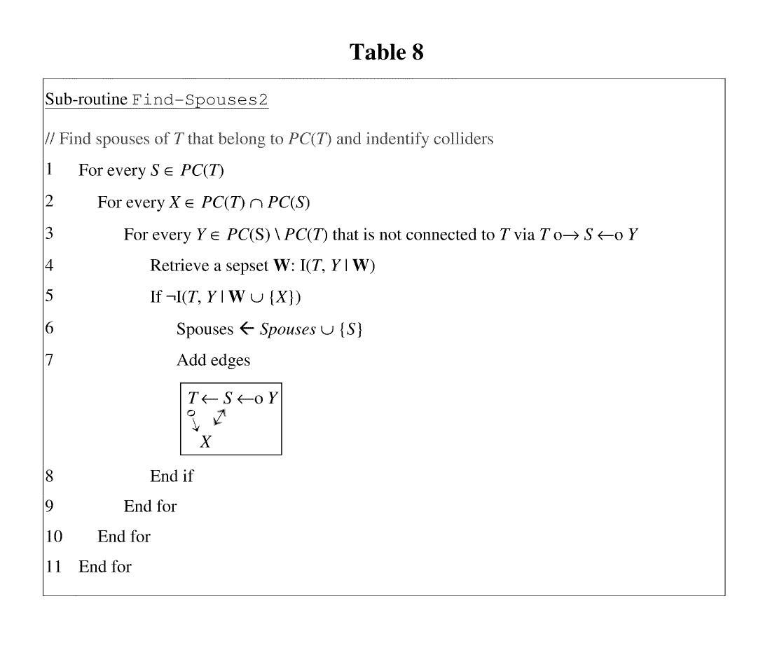

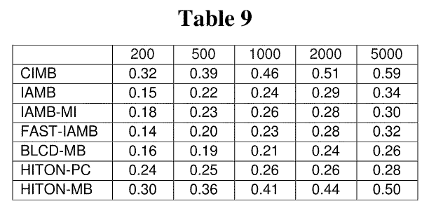

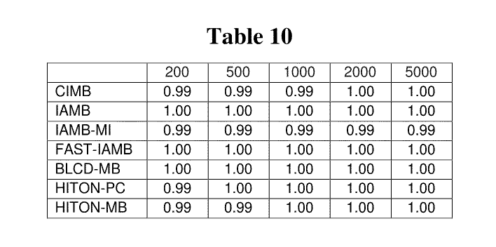

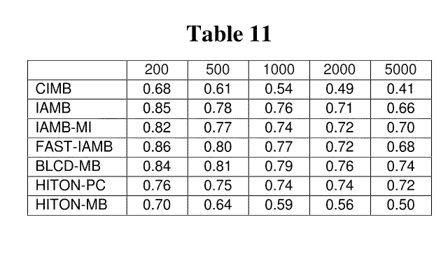

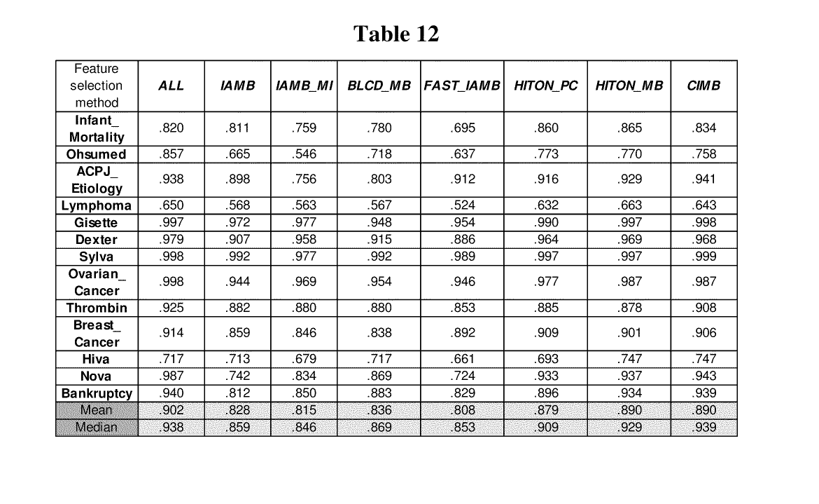

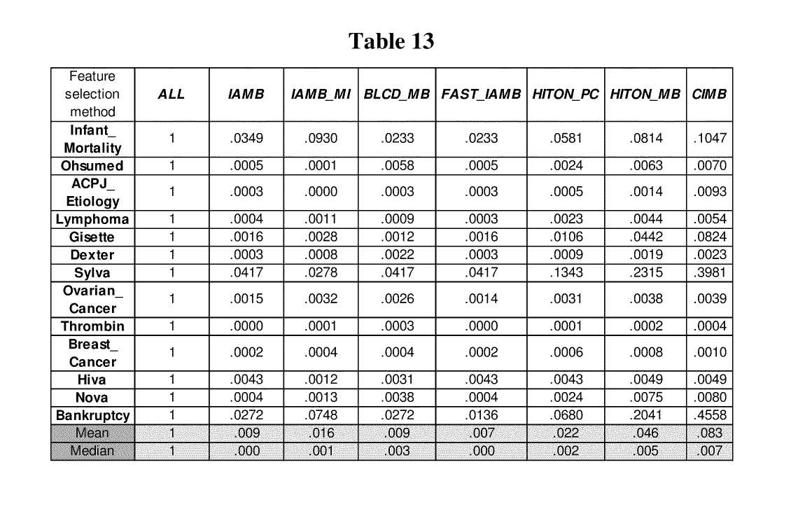

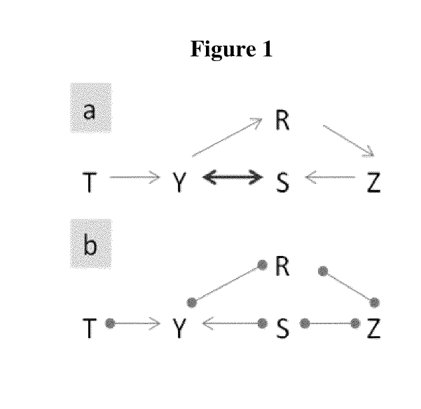

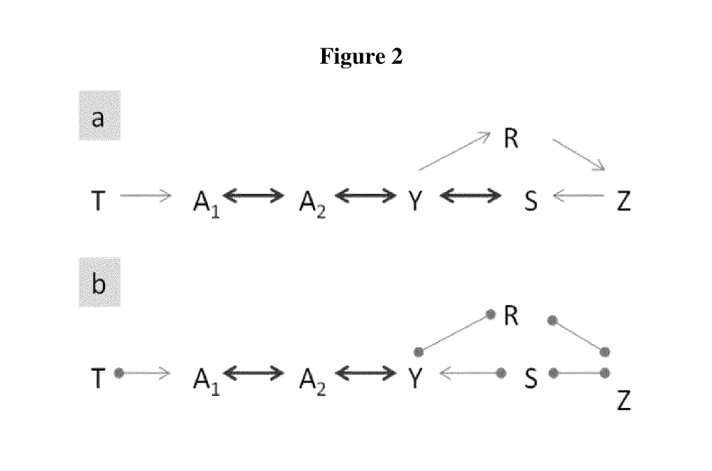

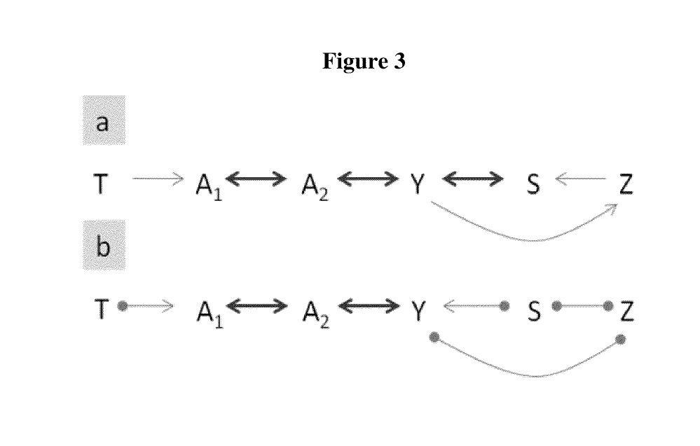

The examples provided below motivate the reasoning behind collider orientation rules that are described in steps 19-29 of the CIMB* method (and denoted as Case A and B in the CIMB* pseudo-code):
Case A (Y and Z are not adjacent): Consider two graphical structures shown in FIGS. 1a and 2a. Assume that CIMB* reached point of its operation when it identified the structures shown in FIGS. 1b and 2b. One wants to determine if Z belongs to a MB(T). For both structures, W={R} is a sepset of Y and Z (i.e., Y is independent of Z given W). Since Y is dependent on Z given W∪{S}={R, S}, Z is MB(T) member.
Case B (Y and Z are adjacent): Consider a graphical structure shown in FIG. 3a. Assume that CIMB* reached point of its operation when it identified the structure shown in FIG. 3b. One wants to determine if Z belongs to MB(T). The sepset W of T and Z is empty. Since T is dependent on Z given W∪{A₁, A₂, Y, S}={A₁, A₂, Y, S}, Z is MB(T) member.

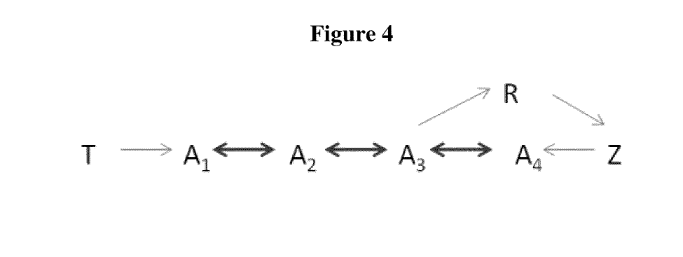

The following describes several ways to obtain variants of the method CIMB* by modifying pseudo-code of the method:
One variant of the CIMB* method (referred to as method CIMB*1) is the same as CIMB* except that it does not consider Case A and applies Case B both when Y and Z are adjacent and when they are not adjacent.
Another heuristic variant of the CIMB* method (referred to as CIMB*2) improves upon CIMB*1 by conditioning not on all variables in the collider path but on subsets of limited size. E.g., consider structure shown in FIG. 4. Assume, one can condition on up to 3 variables. Then if one of the following holds, Z is a member of MB(T): [symbol] I(T, Y|A₁), [symbol] I(T, Y|A₁, A₂), [symbol] I(T, Y|A₁, A_{2,}A₃). Here one hopes that there is a path without colliders between Z and some A, that is located “close” to T. The same approach can be applied to make more sample efficient step 26 of the CIMB* method (Case B).

Illustration of the Limitations of Compositional Markov Boundary Methods

As it was mentioned in this patent document, compositional Markov boundary methods may miss some Markov boundary members if the causal sufficiency assumption is violated (Spirtes et al., 2000). The latter assumption implies that every common cause of any two or more variables is observed in the dataset. Consider a graphical structure shown in FIG. 2a and assume that only variables shown in the figure are observed. Clearly, data generated from this structure violate the causal sufficiency assumption (e.g., common causes of A₁ and A₂ are not observed). Now assume that the probability distribution over all variables (i.e., observed and unobserved) is faithful to the graph and one can make correct inferences about independence relations from a given data sample from the underlying probability distribution. If one applies to the above data HITON-MB (Aliferis et al., 2009a; Aliferis et al., 2009b), a state of the art compositional Markov boundary method, the following Markov boundary of T will be output by the method: {A₁, A₂}. Notice however that this output set of variables does not satisfy the definition of the Markov boundary (Pearl, 1988): variables Y, S, and Z will not be independent from T given {A₁, A₂}. On the other hand, the inventive method will correctly discover and output the Markov boundary {A₁, A₂, Y, S}.

Results of Experiments with Simulated Data from Bayesian Networks

Table S1 shows a list of Bayesian networks used to simulate data. These Bayesian networks were used in prior evaluation of Markov boundary and causal discovery methods (Aliferis et al., 2009a; Aliferis et al., 2009c; Tsamardinos et al., 2006a) and were chosen on the basis of being representative of a wide range of problem domains (emergency medicine, veterinary medicine, weather forecasting, financial modeling, molecular biology, and genomics). For each of these Bayesian networks, data was simulated using a logic sampling method (Russell and Norvig, 2003). Specifically, 5 datasets of 200, 500, 1000, 2000, and 5000 samples were simulated. Notice that all these datasets do not contain hidden variables and thus cannot be used in the original form to demonstrate benefits of the invention. That is why the method stated in Table S3 was applied to generate experiment tuples of the form <T, S, MB_{S}(T)>, where each tuple instructs first to run the invention and baseline comparison method on a target variable T after removing from the dataset variables S and then to compare the output variable set with the correct answer MB_{S}(T).

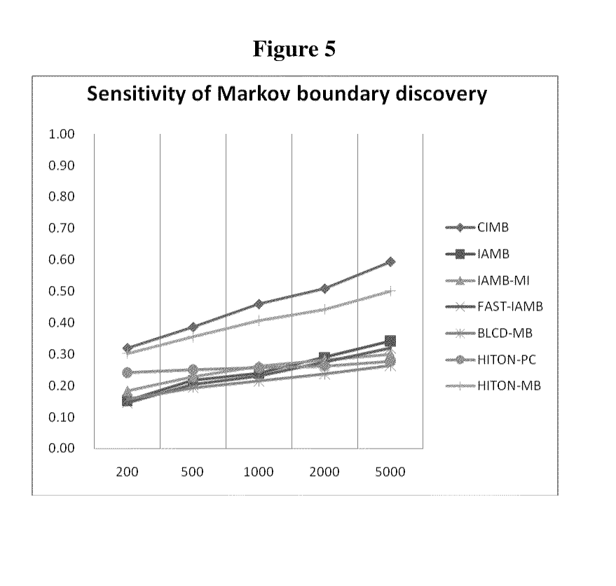

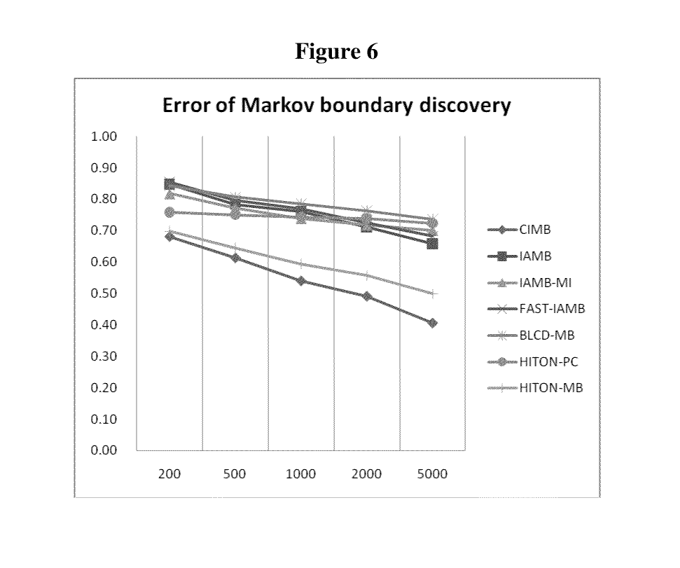

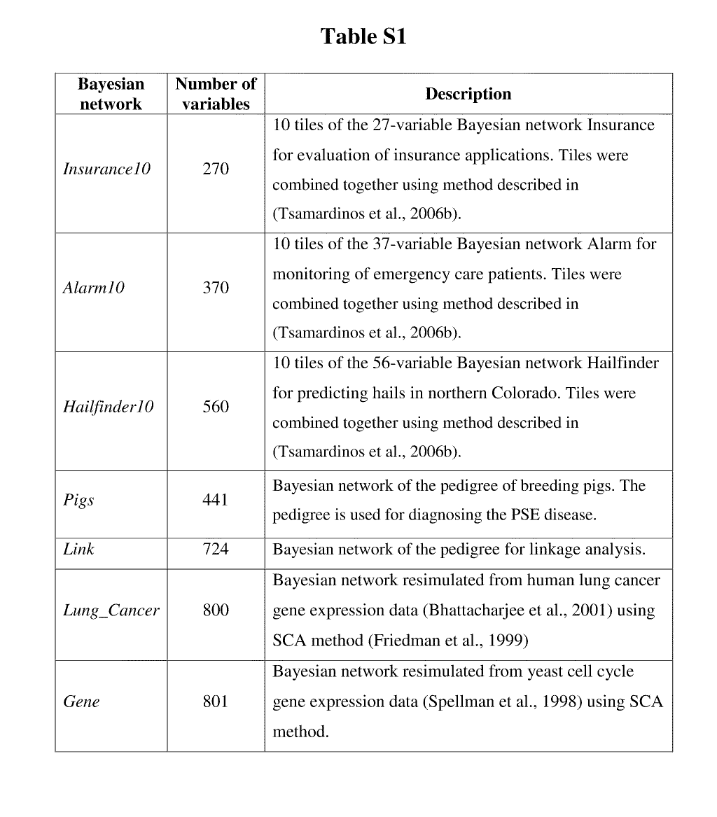

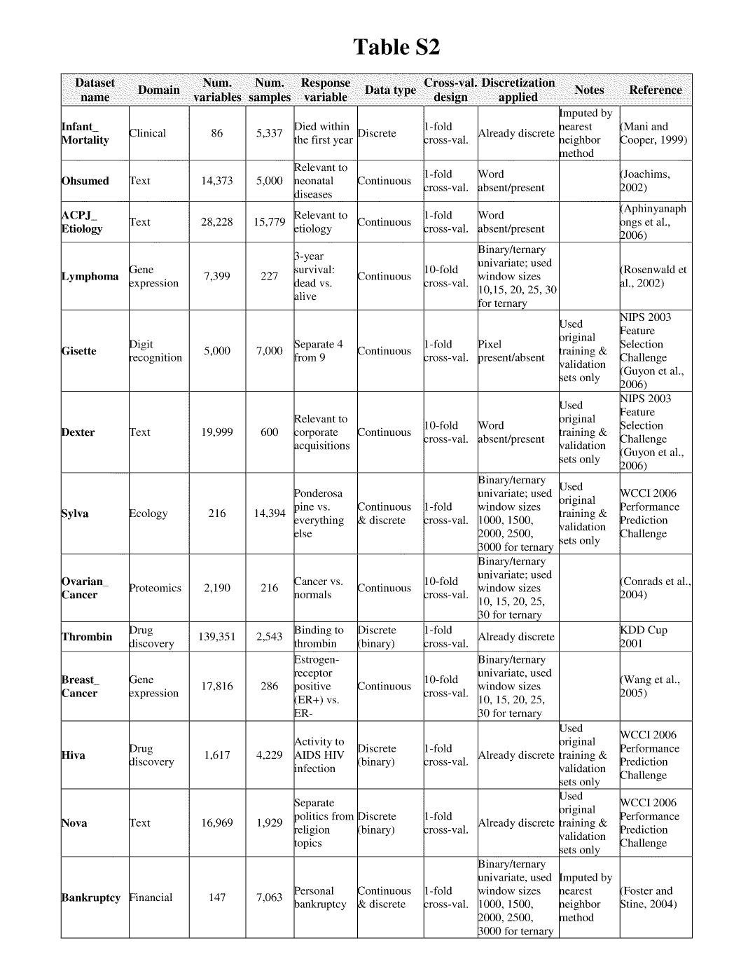

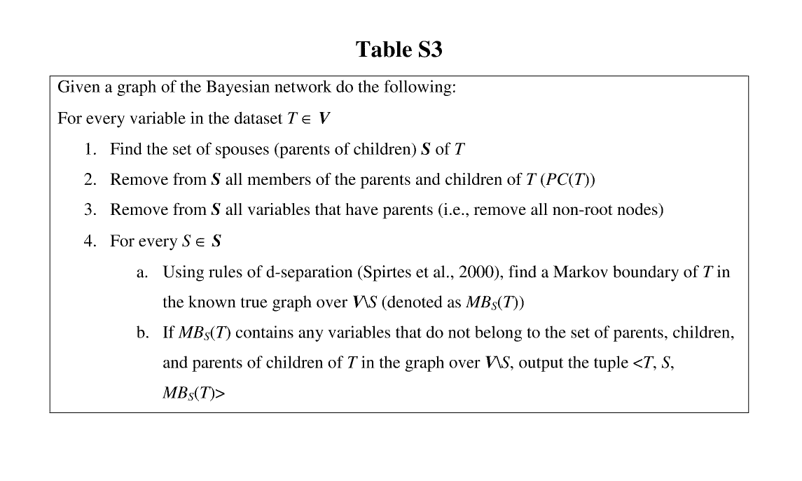

The following Markov boundary methods were applied to those datasets with G² test of statistical independence (Agresti, 2002): CIMB*, IAMB (Tsamardinos and Aliferis, 2003; Tsamardinos et al., 2003b), BLCD-MB (Mani and Cooper, 2004), FAST-IAMB (Yaramakala and Margaritis, 2005), HITON-PC (Aliferis et al., 2009a; Aliferis et al., 2009b), and HITON-MB (Aliferis et al., 2009a; Aliferis et al., 2009b). In addition, IAMB (Tsamardinos and Aliferis, 2003; Tsamardinos et al., 2003b) with mutual information (Cover et al., 1991) (this method is denoted as “IAMB-MI”) was applied. The results for sensitivity, specificity, and error of Markov boundary discovery are shown in Tables 9, 10, 11, respectively. The results for sensitivity and error of Markov boundary discovery are also plotted in FIGS. 5 and 6, respectively. As can be seen, CIMB* yields larger sensitivity (Table 9, FIG. 5) and similar specificity (Table 10) compared to other methods, which results in smaller error of Markov boundary discovery (Table 11, FIG. 6). These results demonstrate the advantages of the invention in terms of accurate detection of the Markov boundary.

Results of Experiments with Real Data from Different Application Domains

Table S2 shows a list of real datasets used in experiments. The datasets were used in prior evaluation of Markov boundary methods (Aliferis et al., 2009a; Aliferis et al., 2009c) and were chosen on the basis of being representative of a wide range of problem domains (biology, medicine, economics, ecology, digit recognition, text categorization, and computational biology) in which Markov boundary induction and feature selection are essential. These datasets are challenging since they have a large number of features with small-to-large sample sizes. Several datasets used in prior feature selection and classification challenges were included. All datasets have a single binary response variable. It is also likely to assume that these datasets have hidden variables (because these are real-life data from domains where only a subset of variables are observed with respect to all known observables in each domain) and the causal sufficiency assumption is violated with certainty. Thus these datasets can be used to demonstrate the benefits of the inventive method.

The following Markov boundary methods were applied to those datasets with G² test of statistical independence (Agresti, 2002): CIMB*, IAMB (Tsamardinos and Aliferis, 2003; Tsamardinos et al., 2003b), BLCD-MB (Mani and Cooper, 2004), FAST-IAMB (Yaramakala and Margaritis, 2005), HITON-PC (Aliferis et al., 2009a; Aliferis et al., 2009b), and HITON-MB (Aliferis et al., 2009a; Aliferis et al., 2009b). In addition, IAMB (Tsamardinos and Aliferis, 2003; Tsamardinos et al., 2003b) with mutual information (Cover et al., 1991) (this method is denoted as “IAMB-MI”) was applied, and likewise the set of all variables in the dataset (denoted as “ALL”) was also included in the comparison. Once features were selected, SVM classifiers were trained and tested on selected features according to the cross-validation protocol stated in Table S2 (Vapnik, 1998). The results are shown in Table 12 (classification performance, measured by area under ROC curve) and Table 13 (proportion of selected features). As can be seen from the row “Median” of Table 12, CIMB* yields larger median classification performance than other methods, including using all variables in the dataset. Specifically, CIMB* achieves the largest classification performance in ACPLEtiology, Gisette, Sylva, and HIVA datasets. In terms of mean classification performance, its results are comparable to the best baseline comparison method (HITON-MB) (Table 12, row “Mean”). At the same time according to Table 13, the proportion of features selected by CIMB* is only a few percent larger than for other Markov boundary methods.

Software and Hardware Implementation:

Due to large numbers of data elements in the datasets, which the present invention is designed to analyze, the invention is best practiced by means of a computational device. For example, a general purpose digital computer with suitable software program (i.e., hardware instruction set) is needed to handle the large datasets and to practice the method in realistic time frames. Based on the complete disclosure of the method in this patent document, software code to implement the invention may be written by those reasonably skilled in the software programming arts in any one of several standard programming languages. The software program may be stored on a computer readable medium and implemented on a single computer system or across a network of parallel or distributed computers linked to work as one. The inventors have used MathWorks Matlab® and a personal computer with an Intel Xeon CPU 2.4 GHz with 4 GB of RAM and 160 GB hard disk. In the most basic form, the invention receives on input a dataset and a response variable index corresponding to this dataset, and outputs a Markov boundary (described by indices of variables in this dataset) which can be either stored in a data file, or stored in computer memory, or displayed on the computer screen. Likewise, the invention can transform an input dataset into a minimal reduced dataset that contains only variables that are needed for optimal prediction of the response variable (i.e., Markov boundary).

### REFERENCES

Agresti, A. (2002 ) Categorical data analysis. Wiley-Interscience, New York, N.Y., USA.
Aliferis, C. F. et al. (2009a) Local Causal and Markov Blanket Induction for Causal Discovery and Feature Selection for Classification. Part I: Algorithms and Empirical Evaluation. Journal of Machine Learning Research.
Aliferis, C. F. et al. (2009b) Local Causal and Markov Blanket Induction for Causal Discovery and Feature Selection for Classification. Part II: Analysis and Extensions. Journal of Machine Learning Research.
Aliferis, C. F. et al. (2009c) Local Causal and Markov Blanket Induction for Causal Discovery and Feature Selection for Classification. Part II: Analysis and Extensions. Journal of Machine Learning Research.
Aliferis, C. F., Tsamardinos, I. and Statnikov, A. (2003) HITON: a novel Markov blanket algorithm for optimal variable selection. AMIA 2003 Annual Symposium Proceedings, 21-25.
Aphinyanaphongs, Y., Statnikov, A. and Aliferis, C. F. (2006) A comparison of citation metrics to machine learning filters for the identification of high quality MEDLINE documents. J. Am. Med. Inform. Assoc., 13, 446-455.
Bhattacharjee, A. et al. (2001) Classification of human lung carcinomas by mRNA expression profiling reveals distinct adenocarcinoma subclasses. Proc. Natl. Acad. Sci. U.S.A, 98, 13790-13795.
Conrads, T. P. et al. (2004) High-resolution serum proteomic features for ovarian cancer detection. Endocr. Relat Cancer, 11, 163-178.
Cover, T. M. et al. (1991) Elements of information theory. Wiley New York.
Foster, D. P. and Stine, R. A. (2004) Variable Selecion in Data Mining: Building a Predictive Model for Bankruptcy. Journal of the American Statistical Association, 99, 303-314.
Frey, L. et al. (2003) Identifying Markov blankets with decision tree induction. Proceedings of the Third IEEE International Conference on Data Mining (ICDM).
Friedman, N., Nachman, I. and Pe'er, D. (1999) Learning Bayesian network structure from massive datasets: the “Sparse Candidate” algorithm. Proceedings of the Fifteenth Conference on Uncertainty in Artificial Intelligence (UAI).
Guyon, I. et al. (2006) Feature extraction: foundations and applications. Springer-Verlag, Berlin.
Joachims, T. (2002) Learning to classify text using support vector machines. Kluwer Academic Publishers, Boston.
Kohavi, R. and John, G. H. (1997) Wrappers for feature subset selection. Artificial Intelligence, 97, 273-324.
Mani, S. and Cooper, G. F. (1999) A Study in Causal Discovery from Population-Based Infant Birth and Death Records. Proceedings of the AMIA Annual Fall Symposium, 319.
Mani, S. and Cooper, G. F. (2004) Causal discovery using a Bayesian local causal discovery algorithm. Medinfo 2004., 11, 731-735.
Margaritis, D. and Thrun, S. (1999) Bayesian network induction via local neighborhoods. Advances in Neural Information Processing Systems, 12, 505-511.
Neapolitan, R. E. (1990) Probabilistic reasoning in expert systems: theory and algorithms. Wiley, New York.
Pearl, J. (1988) Probabilistic reasoning in intelligent systems: networks of plausible inference. Morgan Kaufmann Publishers, San Mateo, Calif.
Peña, J. et al. (2007) Towards scalable and data efficient learning of Markov boundaries. International Journal of Approximate Reasoning, 45, 211-232.
Rosenwald, A. et al. (2002) The use of molecular profiling to predict survival after chemotherapy for diffuse large-B-cell lymphoma. N. Engl. J Med., 346, 1937-1947.
Russell, S. J. and Norvig, P. (2003) Artificial intelligence: a modern approach. Prentice Hall/Pearson Education, Upper Saddle River, N.J.
Spellman, P. T. et al. (1998) Comprehensive identification of cell cycle-regulated genes of the yeast Saccharomyces cerevisiae by microarray hybridization. Mol. Biol Cell, 9, 3273-3297.
Spirtes, P., Glymour, C. N. and Scheines, R. (2000) Causation, prediction, and search. MIT Press, Cambridge, Mass.
Statnikov, A. (2008) Algorithms for Discovery of Multiple Markov Boundaries: Application to the Molecular Signature Multiplicity Problem. Ph. D. Thesis, Department of Biomedical Informatics, Vanderbilt University.
Tsamardinos, I. and Aliferis, C.F. (2003) Towards principled feature selection: relevancy, filters and wrappers. Proceedings of the Ninth International Workshop on Artificial Intelligence and Statistics (AI & Stats).
Tsamardinos, I., Aliferis, C. F. and Statnikov, A. (2003a) Algorithms for large scale Markov blanket discovery. Proceedings of the Sixteenth International Florida Artificial Intelligence Research Society Conference (FLAIRS), 376-381.
Tsamardinos, I., Aliferis, C. F. and Statnikov, A. (2003b) Time and sample efficient discovery of Markov blankets and direct causal relations. Proceedings of the Ninth International Conference on Knowledge Discovery and Data Mining (KDD), 673-678.
Tsamardinos, I., Brown, L. E. and Aliferis, C. F. (2006a) The Max-Min Hill-Climbing Bayesian Network Structure Learning Algorithm. Machine Learning, 65, 31-78.
Tsamardinos, I. et al. (2006b) Generating Realistic Large Bayesian Networks by Tiling. Proceedings of the 19th International Florida Artificial Intelligence Research Society (FLAIRS) Conference.
Vapnik, V. N. (1998) Statistical learning theory. Wiley, New York.
Wang, Y. et al. (2005) Gene-expression profiles to predict distant metastasis of lymph-node-negative primary breast cancer. Lancet, 365, 671-679.
Yaramakala, S. and Margaritis, D. (2005) Speculative Markov Blanket Discovery for Optimal Feature Selection. Proceedings of the Fifth IEEE International Conference on Data Mining, 809-812.

### Appendix

In this specification capital letters in italics denote variables (e.g., A, B, C) and bold letters denote variable sets (e.g., X, Y, Z). The following standard notation of statistical independence relations is adopted: I(T, A) means that T is independent of variable set A. Similarly, if T is independent of variable set A given (conditioned on) variable set B, this denoted as I(T, A|B). If [symbol] I( )” is used instead of “I( ), this means dependence instead of independence.

If a graph contains an edge X→>Y, then X is a parent of Y and Y is a child of X. The edge X [symbol] Y means that X and Y are confounded by hidden variable(s) (i.e., they share at least one unobserved common cause). The edge X o→Y denotes either X→Y or X [symbol] Y. Finally, the edge X o-o Y denotes either X→Y, or X [symbol] Y, or X←Y.

The set of all variables involved in the causal process is denoted by A=V∪H, where V is the set of observed variables (including the response/target variable T) and H is the set of unobserved (hidden) variables.

DEFINITION OF BAYESIAN NETWORK <V, G, J>: Let V be a set of variables and J be a joint probability distribution over all possible instantiations of V. Let G be a directed acyclic graph (DAG) such that all nodes of G correspond one-to-one to members of V. It is required that for every node A ∈ V, A is probabilistically independent of all non-descendants of A, given the parents of A (i.e. Markov Condition holds). Then the triplet <V, G, J> is called a Bayesian network (abbreviated as “BN”), or equivalently a belief network or probabilistic network (Neapolitan, 1990).

DEFINITION OF MARKOV BLANKET: A Markov blanket M of the response/target variable T ∈ V in the joint probability distribution P over variables V is a set of variables conditioned on which all other variables are independent of T, i.e. for every X ∈(V\M\{T}), I(T, X|M).

DEFINITION OF MARKET BOUNDARY: If M is a Markov blanket of T in the joint probability distribution P over variables V and no proper subset of M satisfies the definition of Markov blanket of T, then M is called a Markov boundary of T. The Markov boundary of T is denoted as MB(T).

DEFINITION OF THE SET OF PARENTS AND CHILDREN: X belongs to the set of parents and children of T (denoted as PC(T)) if and only if X is adjacent with T in the underlying causal graph G over variables V.

DEFINITION OF PUTATIVE PARENT: X is a putative parent of Y if X is a parent of Y or X and Y are confounded by hidden variable(s), i.e. X→Y or X [symbol] Y. This can be also denoted as X o→Y.

DEFINITION OF PUTATIVE CHILD: X is a putative child of Y if X is a child of Y or X and Y are confounded by hidden variable(s), i.e. X←Y or X [symbol] Y. This can be also denoted as X←o Y.

DEFINITION OF COLLIDER PATH: X is connected to Y via a collider path p if the length of p is at least two edges and every variable on the path p is a collider. Here are a few examples of collider paths between X and Y:
X→A [symbol] B←Y
X [symbol] A [symbol] B [symbol] Y
X→A←Y
X [symbol] A [symbol] Y

DEFINITION OF BIDIRECTIONAL PATH: X is connected to Y via a bidirectional path p if every edge on the path is [symbol] Here are a few examples of bidirectional paths between X and Y:
X [symbol] A [symbol] B [symbol] Y
X [symbol] A [symbol] Y

We claim:

1. A computer implemented Core method for finding a Markov boundary of the response/target variable in distributions where possibly not all variables have been observed, said method comprising the following steps all of which are performed on a computer:
(a) initialize TMB(T) with an empty set of variables;
(b) find all variables Z₁ that belong to the set of parents and children of the response/target variable T in the distribution over observed variables and add Z₁ to TMB(T);
(c) find all variables Z₂ that have a collider path to T and add Z₂ to TMB(T);
(d) output TMB(T).

2. The method of claim 1 with the following additional step between steps (c) and (d):
(c*) perform backward elimination starting from TMB(T) and update TMB(T) accordingly.

3. The method of claim 1 or 2 where step (b) is implemented with the GLL-PC method and step (c) is implemented with two steps as follows (referred to as CIMB1 in the specification):
(c1) find a variable Z that has a collider path to T and add Z to TMB(T);
(c2) repeat step (c1) until TMB(T) does not change.

4. The method of claim 3 where step (b) is implemented with the GLL-PC method and step (c1) is implemented via repeated applications of the GLL-PC method (referred to as CIMB* in the specification).

5. The method claim 4 where in steps (b) and (c1) a different method to find the set of parents and children of a response variable is used instead of GLL-PC.

6. The method of claim 1 or 2 with the following modifications (referred to as CIMB2 in the specification):
(i) additional step before step (a): learn a causal graph over all measured variables in the dataset, (ii) steps (b) and (c) implemented by finding the sets of variables Z₁ and Z₂ directly from the learned causal graph.

7. A computer implemented CIMB3 method for finding a Markov boundary of the response/target variable in distributions where possibly not all variables have been observed, said method comprising the following steps all of which are performed on a computer:
(a) initialize TMB(T) with an output of GLL-MB for the response variable T;
(b) perform forward selection starting from TMB(T) and update TMB(T) accordingly;
(c) perform backward elimination starting from TMB(T) and update TMB(T) accordingly;
(d) output TMB(T).

8. The method of claim 7 where in step (a) a different method to find a Markov boundary under causal sufficiency assumption that does not necessitate conditioning on the entire Markov boundary is used instead of GLL-MB (e.g., PC, SGS, PCMB).

9. The method of claim 7 where steps (b) and (c) are iterated.

10. The method of claim 8 where steps (b) and (c) are iterated.

11. The method of claim 1 or 6 for transforming the dataset to a reduced form for classification/regression modeling.

12. The method of claim 1 or 6 that is applied after pre-processing of the dataset (e.g., removing variables before applying the method of claim 1 or 6).

13. The method of claim 1 or 6 with additional post-processing of the data/results.

14. The method of claim 1 or 6 applied to all variables in the dataset as response/target variables to induce a Markov network.

15. The method of claim 1 or 6 applied to a set of variables in the dataset as response/target variables to induce regions of the Markov network.

16. The method of claim 1 or 6 executed in a distributed or parallel fashion in a set of digital computers or CPUs such that computational operations are distributed among different computers or CPUs.

17. The method of claim 1 or 6 further comprising: distinguishing among variables direct causes, direct effect, and spouses of the response/target variable.

18. The method of claim 1 or 6 further comprising: identifying potential hidden confounders of the variables observed in the dataset.

19. A computer system comprising hardware and associated software for finding by means of the Core method for finding a Markov boundary of the response/target variable in distributions where possibly not all variables have been observed, said method comprising the following steps:
(a) initialize TMB(T) with an empty set of variables;
(b) find all variables Z₁ that belong to the set of parents and children of the response/target variable T in the distribution over observed variables and add Z₁ to TMB(T);
(c) find all variables Z₂ that have a collider path to T and add Z₂ to TMB(T);
(d) output TMB(T).

20. A computer system comprising hardware and associated software for finding by means of the CIMB3 method for finding a Markov boundary of the response/target variable in distributions where possibly not all variables have been observed, said method comprising the following steps:
(a) initialize TMB(T) with an output of GLL-MB for the response variable T;
(b) perform forward selection starting from TMB(T) and update TMB(T) accordingly;
(c) perform backward elimination starting from TMB(T) and update TMB(T) accordingly;
(d) output TMB(T).

21. The method of claim 20 where in step (a) a different method to find a Markov boundary under causal sufficiency assumption that does not necessitate conditioning on the entire Markov boundary is used instead of GLL-MB (e.g., PC, SGS, PCMB).

22. A computer implemented Core method for transforming a dataset with many variables into a minimal reduced dataset where all variables are needed for optimal prediction of some response/target variable, said method comprising the following steps all of which are performed on a computer:
(a) initialize TMB(T) with an empty set of variables;
(b) find all variables Z₁ that belong to the set of parents and children of the response/target variable T in the distribution over observed variables and add Z₁ to TMB(T);
(c) find all variables Z₂ that have a collider path to T and add Z₂ to TMB(T);
(d) output dataset only for variables in TMB(T).

23. A computer implemented CIMB3 method for transforming a dataset with many variables into a minimal reduced dataset where all variables are needed for optimal prediction of some response/target variable, said method comprising the following steps all of which are performed on a computer:
(a) initialize TMB(T) with an output of GLL-MB for the response variable T
(b) perform forward selection starting from TMB(T) and update TMB(T) accordingly;
(c) perform backward elimination starting from TMB(T) and update TMB(T) accordingly;
(d) output dataset only for variables in TMB(T).

24. The method of claim 23 where in step (a) a different method to find a Markov boundary under causal sufficiency assumption that does not necessitate conditioning on the entire Markov boundary is used instead of GLL-MB (e.g., PC, SGS, PCMB).
